(19) United States
(12) Patent Application Publication
(10) Pub. No.: US 2009/0302016 A1
(43) Pub. Date: Dec. 10, 2009

(54) WELDING PROCESS USING DIRECT CURRENT ("DC") ELECTRIC WELDING MACHINE

(76) Inventor: Bêla Guth, Lauro de Freitas (BR)

Correspondence Address: STITES & HARBISON PLLC, 1199 NORTH FAIRFAX STREET, SUITE 900, ALEXANDRIA, VA, 22314, US

(21) Appl. No.: 12/159,557

(22) PCT Filed: Jun. 28, 2006
(86) PCT No.: PCT/BR06/00131

§ 371 Date: Oct. 14, 2008

(30) Foreign Application Priority Data
Dec. 28, 2005 (BR) PI0505917-8

(51) Int. Cl. B23K 9/095

(52) U.S. Cl. 219/137 PS

(57) ABSTRACT

This invention concerns an improvement in a welding process using direct current (DC), basically comprehending the increase of voltage, in the conventional welding machine 70-80 volts, to 90 volts. Thus, the electric welding arc becomes stable and mild, without warming the electrode excessive and reducing sprinkles and penetration, with only a capillary melting.

### FIELD OF THE INVENTION

The present invention relates to welding process using a direct current (“DC”) electric welding machine.

### DESCRIPTION OF THE PRIOR ART

When applying electrodes at 1.5 mm for welding thin plates, using conventional direct current (“DC”) electric welding any handy welding machine known in the prior art will show many drawbacks and problems.

When thin electrodes of 1.55 mm found in the prior art are used, half electrode is melted and after some time, on the other half electrodes begins to heat up, becoming red colored, making the rest of the welding process impossible. Another drawback found with the electrodes of the prior art is that, promptly upon the beginning of the welding process, the 1.5 mm electrodes start to have undesirable sprinkles that interrupt the electric arc each and every time.

Trying to reduce the sprinkles and reestablishing the electric arc, amperage is increased. However, in this case the electric arc becomes more violent and consequently having a greater penetration into the plates. This will warm up even further the plate being welded, worsening the problem even more.

### SUMMARY OF THE INVENTION

The present invention seeks to provide a welding process using direct current electric welding machines, wherein the open voltage parameter is modified from the conventional modes, between 70-80 volts, to 90 volts; the welding process employing electrodes. The process further including a wave rectifier so as to define a power source with a constant current feature capable of being adjusted for any suitable application.

### DETAILED DESCRIPTION OF THE INVENTION

The present invention is an improvement in the welding process using direct current (“DC”) electric welding machines. The process of the present invention uses the electric arc for welding, employing electrodes widely used in welding in a number of environments such as: workshops and industries.

The process has as a principle a wave rectifier so as to define a power source with a constant current feature capable of being adjusted for a number of applications.

The present invention seeks to provide an improvement in the welding process by using a direct current welding machine capable of eliminating the problems found in prior art.

In the welding process of the present invention there is no need to increase the amperage, enabling a less dangerous and less penetrating process. The welding process of the present invention also prevents undesirable sprinkles that interrupt the electric arc each and every time.

In the present invention the open voltage parameter is modified from the conventional modes, between 70-80 volts, to 90 volts.

The new voltage parameter prevents the occurrence of the sprinkles. Furthermore, the electric arc becomes stable, preventing the second half of the electrode in use to become red and fully melted, without interruption.

1. (canceled)

2. A welding process using direct current electric welding machines, wherein the open voltage parameter is 90 volts.

3. The welding process according to claim 2, wherein the process employs electrodes.

4. The welding process according to claim 2, further including a wave rectifier so as to define a power source with a constant current feature capable of being adjusted for any suitable application.
